(19) United States
(12) Patent Application Publication
(10) Pub. No.: US 2025/0237024 A1
(43) Pub. Date: Jul. 24, 2025

(54) Barrier Gate Optimized for Compact Transport and Simplified Onsite Assembly

(71) Applicant: Origin Point Brands, LLC, Summerville, SC (US)

(72) Inventors: Bryan Rivers Aubrey, Johns Island, SC (US); Paul Brent Gelegotis, Charleston, SC (US)

(73) Assignee: ORIGIN POINT BRANDS LLC, Summerville, SC (US)

(21) Appl. No.: 18/417,058

(22) Filed: Jan. 19, 2024

(51) Int. Cl. E01F 13/06

(52) U.S. Cl. CPC E01F 13/06

(57) ABSTRACT

A barrier gate is provided that includes a stanchion having a first end and a second end and defining an interior hollow, an arm with a third attached to the stanchion and a fourth end, and a brace having a fifth end and a sixth end and defining a brace profile that is smaller than the interior hollow. The barrier gate defines two states: (a) a compact transport state in which the first and second ends of the stanchion reside proximate to the arm and the brace resides within the interior hollow of the stanchion, and (b) a deployed state in which one of the first end and second end is disposed distal to the arm, the fifth end is attached to the stanchion, and the sixth end is attached to the arm.

### BACKGROUND OF THE INVENTION

The present invention relates to a barrier gate and, more particularly, to a barrier gate having a compact transport state with a stanchion residing proximate to an arm and rotatably connected thereto and with a brace residing within the stanchion, and a deployed state with a brace fixing rotation of the stanchion relative to the arm.

Barrier gates serve several functions, including risk reduction by blocking access to dangerous areas, preventing trespass, and delineating property boundaries.

It is desirable to provide a barrier gate design with components that may be manufactured at a first location better suited for economical manufacturing, and assembled there as much as possible, to take advantage of economies of scale. However, such barrier gates then need to be easily and compactly shipped to a second location such as a point of sale, and thereafter easily and compactly transported by a user from a point of sale to a location of use. At the location of use the barrier gate should be of a design that it is easily erected and put into operation.

In such a context, and recognizing the need to minimize shipping costs by maximizing compactness of shipping, it would be desirable for a barrier gate design to comprise a minimal number of components that had been optimized so as to be most densely packed into a shipping container for transport. Optimally, a maximum number of barrier gates, with a minimized amount of used space, could be packed into a shipping container. However, ideally those same components should at the same time be of a design allowing simple erection at a use location, preferably requiring use only of simple and inexpensive tools. These two goals often compete against each other.

In view of the foregoing, the present invention relates to an improvement upon the known systems and methods of barrier gates and provides distinct advantages over the conventional systems and methods.

### SUMMARY OF THE INVENTION

A barrier gate is provided. This invention discovers a barrier gate that is both optimized for compact transport and simplified for onsite assembly. This invention achieves such goals with a minimum number of constituent components that are easily manufactured, may be transported with minimized unused space, and may be deployed onsite with few and easy steps using common tools.

In accordance with certain aspects of certain embodiments of the present technology, a barrier gate may comprise a hollow stanchion, an arm rotatably connected to the stanchion, and a brace, the brace defining a brace profile predetermined to be receivable within the hollow stanchion and attachable to the stanchion and to the arm to fix the rotation of the stanchion relative to the arm. Additionally and/or alternatively, in various embodiments one or more of the following features may also be included:
(a) the stanchion has first and second ends and the arm has third and fourth ends, and the second end is rotatably connected to the third end;
(b) the stanchion, the arm, and the brace are rectilinear;
(c) an extension residing within the arm and extendable therefrom away from the stanchion;
(d) the brace is attachable to the stanchion at an angle to the stanchion of greater than 45°;
(e) a wedge plate attached to the arm and the brace connects to the arm at the wedge plate;
(f) the stanchion carries a hinge plate that is located outboard of the stanchion and opposite the arm; and/or
(g) the brace carries a connection plate and the brace profile includes the connection plate.

In accordance with additional aspects of other embodiments of the present technology, a method of erecting a barrier gate may comprise the steps of providing a barrier gate kit that includes an arm, a stanchion, and a brace, in which barrier gate kit the arm is disposed alongside the stanchion and is hingeably connected thereto, and the brace resides within the stanchion. The brace may be removed from the stanchion and the stanchion may be rotated relative to the arm (or these two steps may be performed in the reverse order), and the rotation of the stanchion relative to the arm may be fixed by connecting the brace to both the stanchion and the arm. Additionally and/or alternatively, in various embodiments one or more of the following features may also be included:
(a) a brace bracket may be attached to the arm and the brace connected to the arm by interfitting with the brace bracket;
(b) the brace may include a connection plate residing within the stanchion in the barrier gate kit, and further including the step of bolting the connection plate to the stanchion;
(c) the arm may carry an extension that telescopically slides relative to the arm;
(d) the barrier gate kit may further include an extension residing within the arm that telescopically extends relative to the arm; and/or
(e) the brace may include a wedge plate at one end, the arm may carry a brace bracket, and further including the step of interfitting the wedge plate with the brace bracket.

In accordance with still further aspects of other embodiments of the present technology, a barrier gate may include a stanchion having a first end and a second end and defining an interior hollow. An arm with third and fourth ends may be attached to the stanchion at the third end. A brace having a fifth end and a sixth end and defining a brace profile that is smaller than the interior hollow may be included. The barrier gate may define two states: (i) a compact transport state in which the first and second ends of the stanchion reside proximate to the arm and the brace resides within the interior hollow of the stanchion; and (ii) a deployed state in which one of the first end and second end is disposed distal to the arm, the fifth end is attached to the stanchion, and the sixth end is attached to the arm. Additionally and/or alternatively, in various embodiments one or more of the following features may also be included:
(a) the third end may be hingeably attached to the stanchion;
(b) the stanchion, the arm, and the brace may be rectilinear;
(c) a beam may be included that extends telescopically from the arm;
(d) a beam may be included that extends telescopically from within the arm; and/or
(e) the stanchion may define a constant first cross-section along the length of the stanchion and the arm may define a constant second cross-section along the length of the arm, the first and second cross-sections being identical.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

The purpose of the Abstract hereinabove is to enable the United States Patent and Trademark Office, and the public generally, to determine quickly from a cursory inspection the nature of the technical disclosure. The Abstract is not provided for interpreting the scope of the claims herein, nor to define the invention or the application, nor to be limiting in any way as to the scope of the invention.

### BRIEF DESCRIPTION OF DRAWINGS

The details of the present invention, as to both its structure and its operation, can be understood with reference to the accompanying drawings, in which:

FIG. 1 is a perspective view of a barrier gate in a compact transport state according to an embodiment of the present invention;

FIG. 2 is an elevation view of a barrier gate in a deployed state according to an embodiment of the present invention;

FIG. 3 is an elevation view of a barrier gate in a deployed state according to an embodiment of the present invention;

FIG. 4 is a side view of a brace of a barrier gate according to an embodiment of the present invention;

FIG. 5 is an enlarged perspective view of a portion of a barrier gate according to an embodiment of the present invention; and

FIG. 6 is a perspective view of a brace bracket of a barrier gate according to an embodiment of the present invention.

It should be noted that the drawings discussed above and below are not to scale in all instances but may have exaggerated dimensions in some respect to illustrate the principles of the invention.

### DETAILED DESCRIPTION OF THE INVENTION

Reference will now be made in detail to the presently preferred embodiments of the invention, one or more examples of which are illustrated in the drawings. Each example is provided by way of explanation of the invention and is not meant as a limitation of the invention. For example, features illustrated or described as part of one embodiment may be used with a second embodiment to yield a third embodiment. It is intended that the present application include such modifications and variations as come within the scope and spirit of the invention. Repeat use of reference characters throughout the present specification and appended drawings is intended to represent the same or analogous features or elements of the invention.

Before any embodiments of the invention are explained in detail, it is to be understood that the invention is not limited in its application to the details of construction or to the arrangement of components set forth in the following description or illustrated in the drawings. The invention is capable of other embodiments and of being practiced or of being carried out in various ways.

It is to be understood that the phraseology used herein is for the purpose of description and should not be regarded as limiting. The use of formatives of the words “include,” “comprise,” and “have” is meant to encompass the items listed thereafter and equivalents thereof, as well as additional items.

Unless specified or limited otherwise, the terms “connected” and “carried by” are used broadly and encompass direct and indirect mountings, connections, supports, or couplings. Further, such phraseology is not limited to physical or mechanical connections or couplings.

As used herein, the terms “above” and “below” are with gravitational reference. Thus, a component is “above” another if, when the present technology is in regular use, that component is gravitationally higher than the other.

A barrier gate 10 is described herein that includes at least three primary components: a stanchion 20, an arm 30, and a brace 40.

The stanchion 20 is configured for attachment to a pole, column, post, wall, fence, wall, barrier, bollard, tree, frame, or other fixture (any one or more of which is hereinafter referred as a “base”) and provides support for the barrier gate 10 assembly. The stanchion 20 is usually attached in an upright orientation, with one end gravitationally higher than the other end.

The stanchion 20 may be rigid. It may be fabricated from metal, wood, carbon fiber, or polymer, or a combination of two or more of those materials. Thus, in some embodiments, the stanchion 20 may be fabricated from corrosion resistant material. In other embodiments, the stanchion 20 may include an exterior coating to inhibit corrosion.

The stanchion 20 may be either rectilinear or curvilinear.

The cross-sectional shape of the stanchion 20 may be rectangular, circular, elliptical, polygonal, or irregular. The stanchion 20 may define a given cross-section only at a certain location along its length, or may define a given, constant cross-section along its entire length.

The stanchion 20 may be hollow or solid, or hollow along one or more portions of its length and solid otherwise.

The stanchion 20 may carry on one side one or more hinge plates, each hinge plate having an aperture configured for rotational attachment to a base.

The arm 30 is configured for attachment to the stanchion 20, in some examples by a rotatable attachment. The arm 30 may be attached to the stanchion 20 at any location along the length of the stanchion 20; in specific instances illustrated in the drawings, the arm 30 has been attached proximate to an end of the stanchion 20.

The arm 30 is usually attached to the stanchion 20 so as to extend generally horizontally therefrom.

The arm 30 may be rigid. It may be fabricated from metal, wood, carbon fiber, or polymer, or a combination of two or more of those materials. Thus, in some embodiments, the arm 30 may be fabricated from corrosion resistant material. In other embodiments, the arm 30 may include an exterior coating to inhibit corrosion. The arm 30 may be fabricated from the same material as the stanchion 20, and in other embodiments the arm 30 may be fabricated from a different material.

The arm 30 may be either rectilinear or curvilinear.

The cross-sectional shape of the arm 30 may be rectangular, circular, elliptical, polygonal, or irregular. The arm 30 may define a given cross section only at a certain location along its length, or may define a given, constant cross section along its length.

The arm 30 may be hollow or solid, or hollow along one or more portions of its length and solid otherwise.

In some embodiments, the cross-sectional shape of the arm 30 may be identical in shape and dimensions to the cross-sectional shape of the stanchion 20. In such embodiments, both the stanchion 20 and the arm 30 may be fabricated from a single length of material, for example an extruded metal, and then cut into a stanchion 20 portion and an arm 30 portion.

The arm 30 may include one or more extensions, such as a first beam 37 or a first beam 37 and a second beam 38, that are extendable away from the attachment of arm 30 to the stanchion 20, thereby lengthening the reach of the barrier gate 10. Such an extension may telescopically slide relative to the arm 30. In specific instances, such an extension may telescopically slide from within the arm 30.

The brace 40 is configured for attachment to both the stanchion 20 and the arm 30, to hold the arm 30 in a generally horizontal orientation and to fix the rotation of the arm 30 relative to the stanchion 20.

The brace 40 may be rigid. It may be fabricated from metal, wood, carbon fiber, or polymer, or a combination of two or more of those materials. Thus, in some embodiments, the brace 40 may be fabricated from corrosion resistant material. In other embodiments, the brace 40 may include an exterior coating to inhibit corrosion. The brace 40 may be fabricated from the same material as the stanchion 20 and/or the arm 30, and in other embodiments the brace 40 may be fabricated from a different material.

The brace 40 may be either rectilinear or curvilinear.

The cross-sectional shape of the brace 40 may be rectangular, circular, elliptical, polygonal, irregular, that of an I-beam, or of other cross-sectional shape. The brace 40 may define a given cross-section only at a certain location along its length, or may define a given, constant cross section along its length.

The brace 40 may be hollow or solid, or hollow along one or more portions of its length and solid otherwise.

The brace 40 may define a brace profile 43, which may be understood to be the vertical height of the brace 40 as measured perpendicularly to a longitudinal line along the longest dimension of the brace 40.

The brace 40 may carry a connection plate 42 at one end that is connectable to the stanchion 20. In such embodiments, the brace profile 43 may be understood to be the vertical height of the brace 40 and connection plate 42 assembly as measured perpendicularly to a longitudinal line along the longest dimension of the brace 40 and connection plate 42 assembly.

The brace 40 may carry a wedge plate 41 at one end and, in those embodiments in which a connection plate 42 is carried at one end of the brace 40, the wedge plate 41 is carried at the opposite end.

In many embodiments of the deployed barrier gate 10 the brace 40 resides at an acute angle to the stanchion 20. In specific instances, that angle is greater than 45°.

In particular usages of the barrier gate 10, plural braces 40 may be used.

The stanchion 20, arm 30, and brace 40 may be interconnected as follows. The arm 30 may be attached to the stanchion 20 with an end of the arm 30 proximate to an end of the stanchion 20. In particular instances, an end of the arm 30 is attached to an end of the stanchion 20. In some embodiments, the attachment between the arm 30 and the stanchion 20 may allow for rotational movement between the arm 30 and the stanchion 20 and, in specific configurations, that rotational movement may be facilitated by a hinge 55.

The optimize for compact transport, the barrier gate 10 may be provided in kit form. In such a kit, a hollow stanchion 20 may be provided and the brace 40, either with or without a connection plate 42, is sized so as to be received within the hollow 21 of the stanchion 20. With the kit, for compact transport the arm 30 may be disposed alongside the stanchion 20 and hingeably connected thereto, with the brace 40 residing within the stanchion 20. To deploy the gate for usage, the brace 40 may be removed from within the stanchion 20 and the arm 30 and brace 40 rotated such that the non-hinged end of the stanchion 20 is distal to the arm 30 (or these two steps are may be undertaken in reverse order), and the brace 40 then attached to the arm 30 and to the stanchion 20.

A brace bracket 33 may be attached to the arm 30, such as during the manufacture of the barrier gate 10 or, in come instances, during the deployment of the barrier gate 10, and the brace 40 may connect to the arm 30 by interfitting with the brace bracket 33. In certain configurations, a wedge plate 41 may be carried at one end of the brace 40 and may interfit with the brace bracket 33 to attach the brace 40 to the arm 30.

The brace 40 may have a connection plate 42 and the connection plate 42 may be attached to the stanchion 20 by bolting the connection plate 42 to the stanchion 20 with a connection plate bolt 72.

As thus configured, the brace 40 fixes the rotation of the stanchion 20 relative to the arm 30. More specifically, by attaching the brace 40 to the stanchion 20 and to the arm 30, the relative angular orientation of the arm 30 to the stanchion 20 may be set.

One or more embodiments of the barrier gate 10 are illustrated in the drawings.

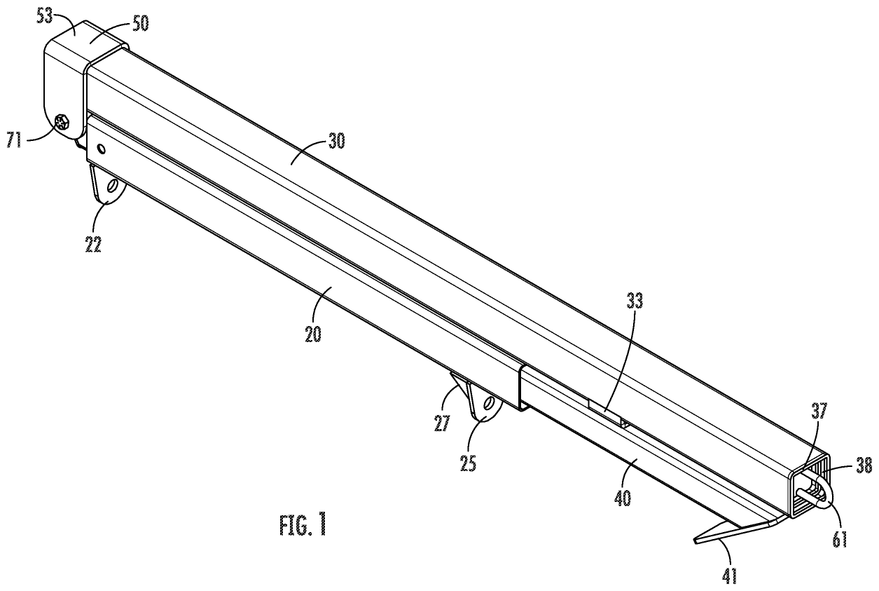

In FIG. 1, a barrier gate 10 kit optimized for compact transport and simplified on site assembly is illustrated. The arm 30 is illustrated as disposed alongside the stanchion 20 and is hingeably connected thereto. A brace 40 resides within the stanchion 20. A straddle bracket 50 is attached to the arm 30 at one end of the arm 30. In a particular configuration, the straddle bracket 50 includes a first leg 51 and a second leg 52 joined across the top by a web 53. In the particular embodiment illustrated in FIG. 1, a first beam 37 is telescopically carried within the arm 30 and a second beam 38 is telescopically carried within the first beam 37. One or both of the first beam 37 and second beam 38 may be extended from the arm 30 upon usage of the barrier gate 10 so as to lengthen the reach of the barrier gate 10; the lengthened reach may then be fixed by tightening a sixth bolt 75 and a seventh bolt 76, which locks the first beam 37 in position relative to the arm 30 and locks the second beam 38 in position relative to the first beam 37, respectively, as the case may be. A first lock loop 61 is attached to the aspect most distal to the stanchion 20 in a particular usage of the barrier gate 10, be that an end of the arm 30, an end of the first beam 37, or an end of the second beam 38 as the case may be, and is configured for attachment to a fixture to thereby hold the barrier gate 10 either opened or closed. The stanchion 20 carries a first hinge plate 22 and a second hinge plate 25. An optional feature is illustrated in FIG. 1: a gusset 27 is attached both to the second hinge plate 25 and to the stanchion 20, to further increase the strength of the connection of the second hinge plate 25 to the stanchion 20. A connection plate 42 is attached to the end of the brace 40 that is carried within the stanchion 20, but because both the brace 40 and that connection plate 42 has been received within the stanchion 20 in the kit illustrated in FIG. 1, the connection plate 42 is not visible in the illustration of FIG. 1 as it resides within the hollow 21 of the stanchion 20. A wedge plate 41 is included at an end of the brace 40, and a brace bracket 33 is carried by the arm 30. A straddle bracket bolt 71 is received through the first leg 51 of the straddle bracket 50 and the second leg 52 of the straddle bracket 50, but in the embodiment of the kit illustrated in FIG. 1 the straddle bracket bolt 71 has not yet been received by an aperture defined within the stanchion 20.

It will be appreciated that the barrier gate 10, in the kit illustrated in FIG. 1, has been optimized for compact transport. Specifically, multiple units of such barrier gate 10 may be manufactured at a first location then packed for shipment to a second location. With the barrier gate 10 in the folded, compact configuration illustrated in FIG. 1, multiple such units may be compactly loaded in a box, truck, ocean freight container, or other package for such transport to the second location with minimized unused space. The efficiency of such arrangement may be compared to a box of toothpicks.

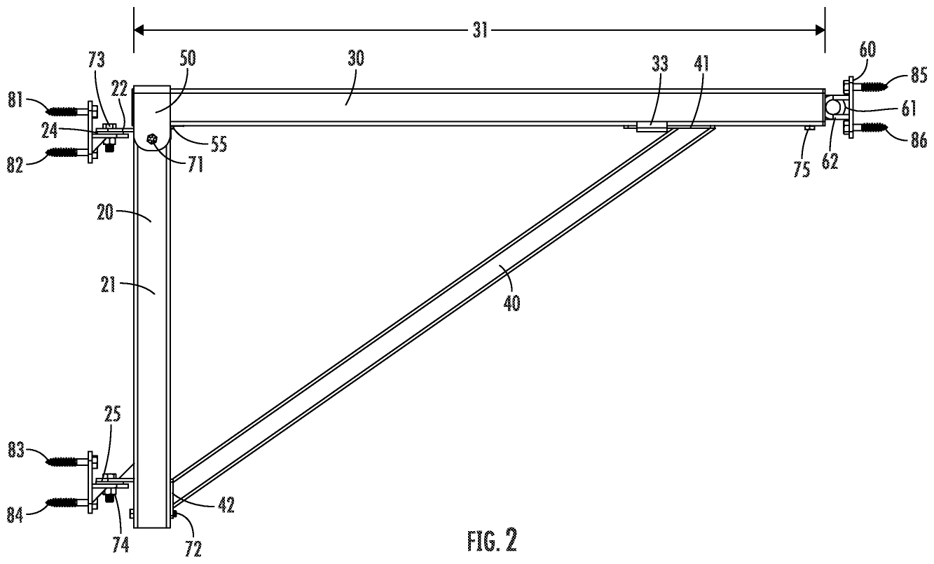

FIG. 2 illustrates a barrier gate 10 in a deployed state. The stanchion 20 has been rotated relative to the arm 30 such that an end of the stanchion 20 is disposed distal to the arm 30. A brace 40 has been attached to the stanchion 20 by use of a connection plate 42; a connection plate 42 bolt has been disposed through the connection plate 42 and through the stanchion 20 to attach the brace 40 to the stanchion 20. Likewise, the brace 40 has been attached to the arm 30. In the embodiment illustrated in FIG. 2, the brace 40 has been attached to the arm 30 by use of a brace bracket 33 carried by the arm 30—a wedge plate 41 carried at one end of the brace 40 has been interfitted with the brace bracket 33.

The embodiment illustrated in FIG. 2 likewise includes a straddle bracket 50 attached to the end of the arm 30 proximate to the stanchion 20. Such attachment of the straddle bracket 50 to the arm 30 may be by weldment or other suitable means during the manufacture of the barrier gate 10, or it may be attached in the field during deployment and usage of the barrier gate 10. In the deployed state illustrated in FIG. 2, a straddle bracket bolt 71 has been interfitted through the first leg 51 and second leg 52 of this straddle bracket 50 and also through an the end of the stanchion 20. Use of the straddle bracket 50, bolted to the stanchion 20 with a straddle bracket bolt 71, strengthens the barrier gate 10 in the deployed state.

The stanchion 20 illustrated in FIG. 2 carries a first hinge plate 22 and a second hinge plate 25 on the side of the stanchion 20 opposite the extension of the arm 30. Likewise illustrated in FIG. 2 is a first hinge bracket 24 and a second hinge bracket 26, positioned for attachment to a base. A first lag screw 81 and a second lag screw 82 may be used to fix the first hinged bracket to a base, although other methods of attachment may be used. Similarly, a third lag screw 83 and a fourth lag screw 84 may be used to attach the second hinge bracket 26 to a base. A first hinge bolt 73 is disposed through both the first hinge plate 22 and the first hinge bracket 24. Likewise, second hinge bolt 74 is disposed through the second hinge plate 25 and second hinge bracket 26. So configured, the barrier gate 10 may swing up on the axis of the first hinge bolt 73 and the second hinge bolt 74.

The illustration the barrier gate 10 illustrated in FIG. 2 also includes a hollow stanchion 20.

The embodiment illustrated in FIG. 2 further includes a first lock loop 61 attached to the end of the arm 30 distal to the stanchion 20. Also illustrated in FIG. 2 is a lock plate 60 with a second lock loop 62, may be secured with a fifth lag screw 85 and a sixth lag screw 86 to a base. The shackle of a lock (not illustrated) may be disposed through the overlapping first lock loop 61 and second lock loop 62, thereby securing the barrier gate 10 and prohibiting passage therethrough.

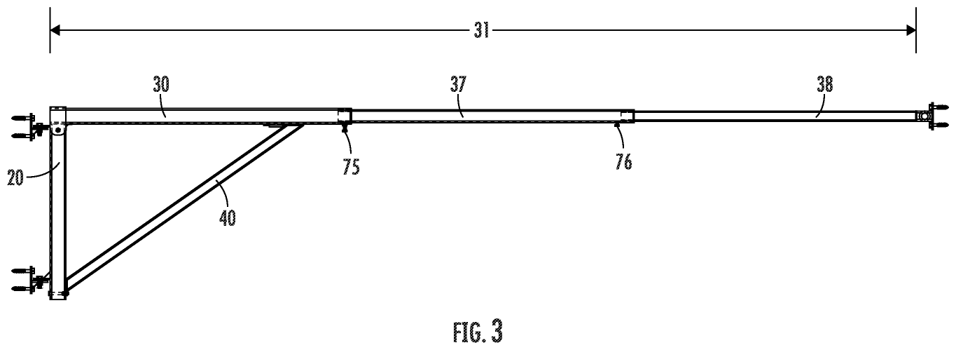

As illustrated in FIG. 2, the arm 30 alone may provide a first width 31 to the barrier gate 10. As illustrated in FIG. 3, use of a first or a first and second extension may provide a greater, second width 32 to the barrier gate 10.

With reference to both FIG. 1 and FIG. 2, the barrier gate 10 has been optimized for compact transport, as described above, but also provides for simplified onsite assembly. The barrier gate 10 kit illustrated in FIG. 1 includes the arm 30, the stanchion 20, and the brace 40, with the arm 30 disposed alongside the stanchion 20 and hingeably connected thereto, and the brace 40 resides within the stanchion 20. The kit illustrated in FIG. 1 may be deployed by removing the brace 40 from the stanchion 20 and rotating the stanchion 20 relative to the arm 30, or alternatively by rotating the stanchion 20 relative to the arm 30 and then removing the brace 40 from the stanchion 20, the sequence of these steps not being prioritized. The relative angular relationship of the arm 30 to the stanchion 20 maybe fixed by connecting the brace 40 to both the stanchion 20 and the arm 30. In the embodiments illustrated in FIGS. 1 and 2, the arm 30 carries a brace bracket 33 and the brace 40 carries a wedge plate 41. The wedge plate 41 may be fitted into the brace bracket 33. Then, because the brace 40 also carries a connection plate 42, the connection plate 42 may be bolted to the stanchion 20. Then, the straddle bracket bolt 71 may be inter fitted through the first leg 51 of the straddle bracket 50, through the stanchion 20, and through the second leg 52 of the straddle bracket 50, thereby providing greater structural strength to the barrier gate 10. The stanchion 20 may then be, if it has not already been, attached to a base. If additional width is desired of the barrier gate 10 and if it includes one or more beams 37, 38, the beam(s) 37, 38 may be extended from the arm 30 to provide the additional width.

FIG. 3 illustrates a barrier gate 10 that includes a first beam 37 and a second beam 38. Both the first beam 37 and the second beam 38 have been extended from the arm 30 so as to provide a second width 32 that is greater than the first width 31 illustrated in FIG. 2. The position of the first beam 37 relative to the arm 30 has been fixed by tightening of the sixth bolt 75. The position of the second beam 38 relative to the first beam 37 has been fixed by tightening of the seventh bolt 76.

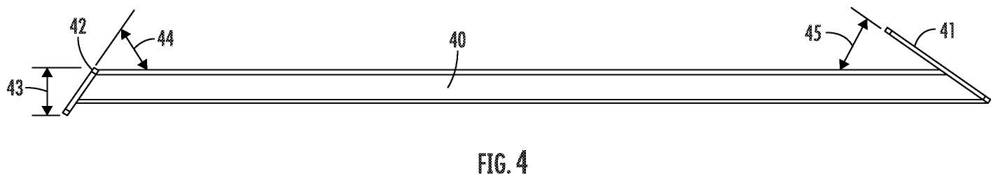

FIG. 4 illustrates an example of a brace 40 that includes a connection plate 42 at one end and a wedge plate 41 at the other end; in the illustrated example, both the connection plate 42 and the wedge plate 41 have been welded to the respective ends of the brace 40. A brace 40 will define a brace profile 43. That brace profile 43 may be understood to be the vertical height of the brace 40 as measured perpendicularly to a longitudinal line along the longest dimension of the brace 40. In the example illustrated in FIG. 4, the brace 40 includes a connection plate 42 and, in such an embodiment, the brace profile 43 may be understood to be the vertical height of the brace 40 plus connection plate 42 assembly as measured perpendicularly to a longitudinal line along the longest dimension of the brace 40, as illustrated in FIG. 4. The brace 40 of FIG. 4 is rectilinear, but the present invention does not require that the brace 40 be rectilinear; instead, it may be curvilinear or of another configuration. Brace 40 in FIG. 4 has been configured with a connection plate 42 residing at a first angle 44, which will define the angle at which the brace 40 will reside relative to the stanchion 20; brace 40 has also been configured with a wedge plate 41 residing at a second angle 45, which will define the angle at which the brace 40 will reside relative to the arm 30.

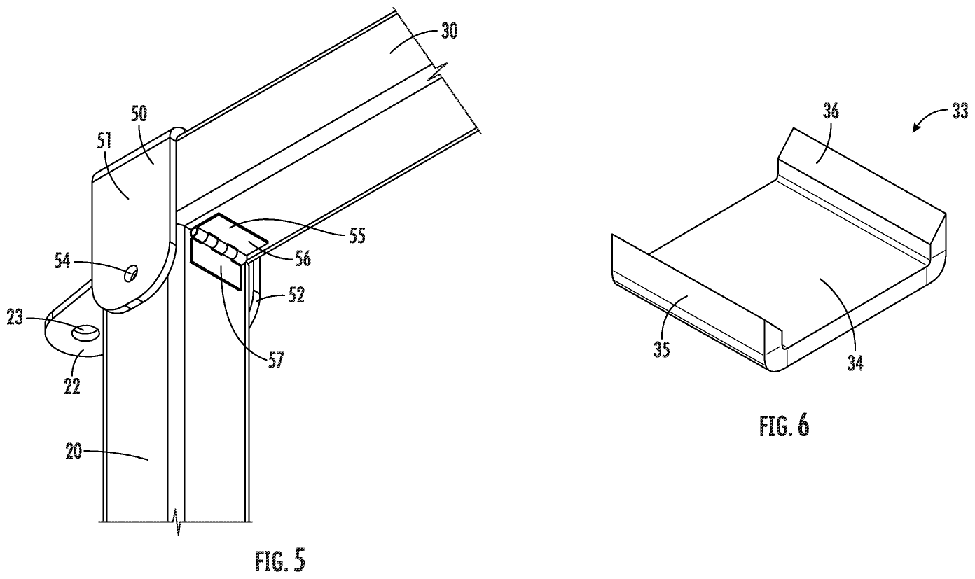

FIG. 5 illustrates an embodiment of the subject barrier gate 10 in which the arm 30 has been rotatably connected to the stanchion 20. The rotatable connection is facilitated by attachment of a hinge 55 on the inside angle of the juncture between the arm 30 and the stanchion 20. A first leaf 56 of the hinge 55 may be attached to the arm 30 and a second leaf 57 of the hinge 55 may be attached to the stanchion 20. So configured, the arm 30 and stanchion 20 may rotate relative to each other.

FIG. 5 also illustrates that a straddle bracket 50 may be attached to the arm 30, either during the manufacture of the barrier gate 10 or during its assembly in the field. The straddle bracket 50 may include a second aperture 54, through which a straddle bracket bolt 71 may be inserted through both the first leg 51 and the second leg 52 of the straddle bracket 50 and through the stanchion 20. Also illustrated in FIG. 5 is inclusion of a first hinge plate 22 attached to the stanchion 20 that includes a first aperture 23 for receipt of a first hinge bolt 73.

FIG. 6 illustrates a configuration of a brace bracket 33, configured to be attached to the arm 30 of the barrier gate 10. The brace bracket 33 includes a floor 34 and opposed first wing 35 and second wing 36. The first wing 35 and the second wing 36 may be attached to the arm 30, for example by weldment, to provide a gap between the arm 30 and the floor 34 of the brace bracket 33. A wedge plate 41 attached to the brace 40, as illustrated in FIG. 4, may be interfitted into the gap between the floor 34 of the brace bracket 33 and the arm 30. However, other methods of attachment, such as by bolting, may be used to attach the brace 40 to the arm 30.

Accordingly, the barrier gate 10 aforedescribed provides for compact transport and simplified onsite assembly. The barrier gate 10 minimizes the number of its constituent components, may be efficiently manufactured, may be transported with minimized unused space, and may be deployed onsite with few steps and common tools.

It should be appreciated that, in the above description of embodiments, various features are sometimes grouped together in a single embodiment, figure, or description for the purpose of streamlining the disclosure and aiding in the understanding of one or more of the various inventive aspects. This method of disclosure, however, is not be interpreted as reflecting an intention that any claim requires more features than are expressly recited in that claim. Moreover, any components, features, or steps illustrated and/or described in a particular embodiment herein, can be applied to or used with any other embodiment. Thus, it is intended that the scope of the inventions herein disclosed should not be limited by the particular embodiments described above, but should be determined only by a fair reading of the claims that may issue from the benefit of the within disclosure.

1. A barrier gate, comprising:
a hollow stanchion;
an arm rotatably connected to the stanchion;
an extension residing within the arm and extendable therefrom away from the stanchion;
a brace, the brace defining a brace profile predetermined to be receivable within the hollow stanchion; and
the brace attachable to the stanchion and to the arm to fix the rotation of the stanchion relative to the arm.

2. (canceled)

3. (canceled)

4. (canceled)

5. A barrier gate, comprising:
a hollow stanchion;
an arm rotatably connected to the stanchion;
a brace, the brace defining a brace profile predetermined to be receivable within the hollow stanchion; and
the brace attachable to the stanchion at an angle to the stanchion of greater than 45° and attachable to the arm to fix the rotation of the stanchion relative to the arm.

6. (canceled)

7. (canceled)

8. (canceled)

9. (canceled)

10. (canceled)

11. (canceled)

12. (canceled)

13. (canceled)

14. (canceled)

15. A barrier gate, comprising:
a stanchion, the stanchion having a first end and a second end and defining an interior hollow;
an arm with third and fourth ends, the third end attached to the stanchion;
a beam that extends telescopically from the arm;
a brace, the brace having a fifth end and a sixth end and defining a brace profile that is smaller than the interior hollow;
wherein the barrier gate defines two states:
a compact transport state in which the first and second ends of the stanchion reside proximate to the arm, and the brace resides within the interior hollow of the stanchion; and
a deployed state in which one of the first end and second end is disposed distal to the arm, the fifth end is attached to the stanchion, and the sixth end is attached to the arm.

16. (canceled)

17. (canceled)

18. (canceled)

19. The barrier gate of claim 15, in which the beam extends telescopically from within the arm.

20. (canceled)
